(19) United States
(12) Patent Application Publication
(10) Pub. No.: US 2020/0057417 A1
(43) Pub. Date: Feb. 20, 2020

(54) BLOCKCHAIN-BASED OPTIMIZATION METHOD FOR COMPLEX SCENARIOS IN ENERGY SYSTEM

(71) Applicants: SHANGHAI JIAOTONG UNIVERSITY, Shanghai (CN); Tsinghua University, Beijing (CN); China Electric Power Research Institute, Beijing (CN); State Grid Hebei Electric Power Supply Co., LTD., Shijiazhuang (CN)

(72) Inventors: JIAN PING, Shanghai (CN); SIJIE CHEN, Shanghai (CN); ZHENG YAN, Shanghai (CN); CHONGQING KANG, Beijing (CN); LIANGZHONG YAO, Beijing (CN); MINHUI QIAN, Beijing (CN); LIANG TANG, Shijiazhuang (CN); CHENJUN SUN, Shijiazhuang (CN); ZHUORAN WANG, Shijiazhuang (CN)

(21) Appl. No.: 16/453,815

(22) Filed: Jun. 26, 2019

(30) Foreign Application Priority Data
Aug. 14, 2018 (CN) 201810920368.8

(51) Int. Cl. G05B 13/04; G06F 16/27; G06Q 50/06

(52) U.S. Cl. CPC G05B 13/042; G06Q 50/06; G06F 16/27

(57) ABSTRACT

A blockchain-based optimization method for complex scenarios in an energy system, in which an optimization problem is solved by nodes in the whole network after initialization, a node that solves the problem most quickly obtains a block accounting right and performs a broadcast to the whole network, other nodes verify the correctness of the received block, and the verified block is the global optimal solution of an energy system optimization model. The energy blockchain model provided by the invention can meet the performance demands of complex scenarios in the energy system optimization for safety, openness, throughput capacity and has the landing and application capability.

This application claims priority to Chinese Patent Application Ser. No. CN201810920368.8 filed on 14 Aug. 2018.

### TECHNICAL FIELD

The invention relates to a technology in the field of smart grid, in particular to a blockchain-based optimization method for complex scenarios in an energy system.

### BACKGROUND ART

The blockchain, as a decentralized, trustless, open and transparent information technology, provides a brand-new solution in order to solve the trust problem among different individuals of an energy system and improve the fairness and efficiency of the system. However, the existing research has not explored the specific implementation of the application scheme on the blockchain; or the existing research is developed based on an existing blockchain platform without considering the defects of the existing blockchain platform in operation efficiency and expandability; or only a scenario with a simple model in the energy system is considered. In addition, the energy system also involves a large amount of physical constraints aside from value flow, and the complexity of the energy system is much higher than the traditional industries most of which have already owned blockchain applications. Currently, underlying technologies of blockchain, such as Ethereum, hyperledger, and bitcoin, have been widely used. However, the existing blockchain technology is not adept at solving large-scale complex optimization problems of the energy system, and is not applicable to systems with a large number of nodes, such as the energy system, in terms of safety and expandability.

### SUMMARY OF THE INVENTION

In order to solve the above defects in the prior art, the present invention provides a blockchain-based optimization method for complex scenarios in an energy system, which urges each node to collect data published by all nodes of the whole network and establishes an optimization model through a proof of optimization (PoO) consensus mechanism, and obtains a solution. A node that solves the problem most quickly obtains a block accounting right of a block, packs the obtained solution into the block, and broadcasts the block to the whole network to obtain certain economic incentives. The present invention solves the problems of low efficiency, poor expandability and even insolubility when the existing blockchain model is applied to a complex optimization scenario of the energy system, and provides an energy blockchain model which is safe, open, high in throughput capacity, expandable and meets the demands of the energy system.

The invention is implemented through the following technical scheme.

The invention relates to a blockchain-based optimization method in an energy system, in which an optimization problem is solved by nodes in the whole network after initialization; node that solves the problem most quickly obtains a block accounting right and performs a broadcast to the whole network; other nodes verify the correctness of received blocks; a verified block is the global optimal solution of an energy system optimization model.

The initialization means that the intrinsic scenario information of the power system is recorded in a genesis block which is used for defining the intrinsic information of the scenario: S₀=<T_{b}, X, f₀(X₀), g₀(X₀), h₀(X₀), cᵢ(X), dᵢ(X)>, i ∈ [0, n], in which T_{b} is an appointed block time.

The block includes a block header and a block body, in which the block header stores the root hash values of a variable tree, an objective function tree, a constraint tree, and a Lagrange multipliers tree in the model, and the block body stores variables, an objective function, constraints, and Lagrange multipliers in an MPT tree format. Preferably, the block body further includes a variable tree (VT), an objective tree (OT), a constraint tree (CT), a k-multiplier tree (kT), and a pt-multiplier tree (μT).

The optimization problem is solved by nodes in the whole network, that is, each node broadcasts the energy system optimization model and constraints to the whole network, and collects and packs all legal broadcasts into a block.

The energy system optimization model refers to:

min(Σᵢ₌₀^{N}fᵢ(Xᵢ)),

s.t. gᵢ(Xᵢ)=0, i ∈ [0, N],

hᵢ(Xᵢ)≤0, i ∈ [0, N],

cᵢ(X)=0, i ∈ [0, N],

dᵢ(X)≥0, i ∈ [0, N], in which N+1 is the number of decision variables, the ith group of decision variables Xi corresponds to a relatively independent objective function fᵢ(Xᵢ) and simple constraint sets gᵢ(Xᵢ) and hᵢ(Xᵢ); X is a set of all decision variables, and constraint sets cᵢ(X) and dᵢ(X) are complex constraints that couple each group of decision variables.

The Lagrange function of the energy system optimization problem is

L=Σᵢ₌₀^{N}(fᵢ(Xᵢ)+λᵢgᵢ(Xᵢ)+μᵢhᵢ(Xᵢ)+αᵢcᵢ(X)+βᵢdᵢ(X)), in which L is the Lagrange function of the problem, λᵢ, μᵢ, αᵢ, and βᵢ are Lagrange multipliers for each constraint of the optimization model respectively.

The block accounting right means that the node that solves the problem most quickly packs the solution result of the optimization problem into the block and performs the broadcast to the whole network, which specifically means that the node i that solves the problem most quickly will broadcast information Sᵢ=<X_{L}, fᵢ(Xᵢ), gᵢ(Xᵢ), hᵢ(Xᵢ)>, thereof to the whole network, other nodes in the network firstly add the collected the information to the objective tree and the constraint tree respectively, solve the optimization model after collecting all information, update the variable tree, the λ-multiplier tree and the μ-multiplier tree according to the solution result, and produce a new block and broadcast to the whole network.

The correctness verification means that other nodes verify the KKT condition in the received block (Karush-Kuhn-Tucher, a necessary and sufficient condition of an optimal solution for the optimization problem), which specifically means that the optimality of the solution involved in the block which is determined and verified according to each constraint of the Lagrange function of the optimization model after the node receives the new block, including ∂L/∂X=0, μ*ᵢhᵢ(X*ᵢ)=0, i ∈ [0, n], β*ᵢdᵢ(X*)=0, i ∈ [0, n], λ*ᵢ, α*ᵢ ≠0, i ∈ [0, n], μ*ᵢ, β*ᵢ≥0, i ∈ [0, n], in which X* is an optimal solution set of all decision variables in the new block, X*ᵢ is the optimal solution of the decision variable Xᵢ in the new block; λ*ᵢ, μ*ᵢ, α*ᵢ, β*ᵢ are the Lagrange multipliers in the new block respectively; and the node confirms the block, broadcasts to the whole network, and starts to contend for the next block when the new block satisfies the above determination which means that the solution in the block is the global optimal solution for the problem.

### Technical Effects

Compared to the prior art, the present invention introduces the PoO consensus mechanism into the blockchain model to replace the traditional blockchain consensus mechanism and correct the defects that the traditional mechanism is high in cost and unable to solve an optimization model; provides a PoO quick verification method based on KKT condition, and realizes distributed network consensus under the PoO mechanism; and designs a block structure suitable for storing variables and parameters of the energy system. The consensus mechanism designed by the present invention allows the blockchain to be applied to complex scenarios in the energy system, and has the advantages of high safety, high openness and high throughput capacity.

### BRIEF DESCRIPTION OF THE DRAWINGS

FIG. 1 is an operational flow chart of an energy blockchain proposed by the present invention;

FIG. 2 is a structural schematic diagram of an energy blockchain block proposed by the present invention;

FIG. 3 is a 24-hour uncontrollable load curve adopted in one embodiment of the present invention;

FIG. 4 is a diagram illustrating the relationship between the PoO solution time and the number of controllable units in one embodiment of the present invention.

### DESCRIPTION OF EMBODIMENTS

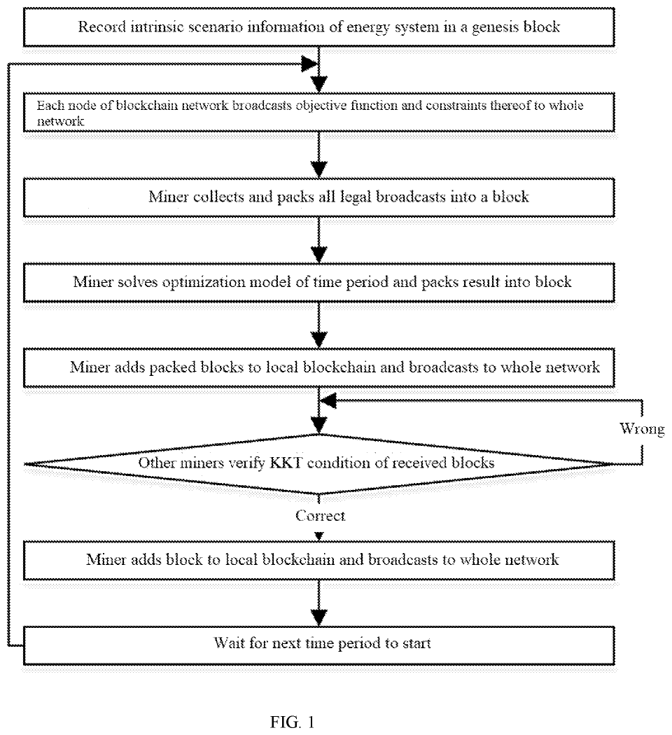

FIG. 1 shows a blockchain-based optimization method in an energy system that the present embodiment relates to, including the following steps:

step 1, the intrinsic scenario information of the energy system is recorded in a genesis block;

step 2, each node of a blockchain network, i.e., a miner, broadcasts an objective function and constraints thereof to the whole network;

step 3, the node collects and packs all legal broadcasts into a block;

step 4, the node solves the optimization model of the time period, and packs the result into the block;

step 5, the node adds the packed blocks to a local blockchain and broadcasts to the whole network;

step 6, other nodes verify the KKT condition of the received blocks after receiving the blocks, discard the block if the verification is wrong; and enter step 7 if the verification is correct; and

step 7, the node adds the block to the local blockchain, broadcasts to the whole network, and completes a generation process of the block in the time period.

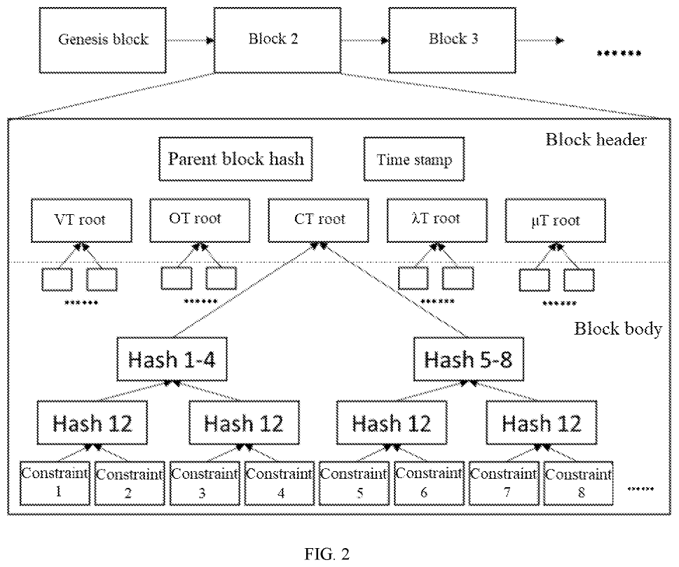

FIG. 2 is a structural schematic diagram of an energy blockchain block in the present embodiment.

The block header includes a parent block hash, a time stamp, and the root hash values of a variable tree, an objective tree, a constraint tree, a λ-multiplier tree and a μ-multiplier tree;

The block body stores variables, an objective function, constraints, a λ-multiplier and a μ-multiplier of the model in an MPT tree format.

The present embodiment divides the distribution network participating individuals into four classes: controllable distributed generation (CDG), uncontrollable distributed generation (UDG), intelligent load (IL), and conventional load (CL).

In terms of time scale, 15 minutes is taken as a time period. UDG and CL respectively submits a predicted output/load curve of several time periods in the future to the distribution network in each time period; CDG submits cost functions and personal constraints; and IL submits personal constraints. The system arranges future plans for power generation and utilization according to the data submitted by the individuals.

The objective function of the present embodiment is to minimize the overall operating cost of the system: min(Σₜ₌₁^{T}(Σ_{i∈S}_{_{bus}} C(P_{i,t}^{CDG})+πₜ^{IM}Pₜ^{IM})), in which T is the number of time periods to be considered, S_{bus} is a set of all buses of the distribution network, C(P_{i,t}^{CDG}) is the cost function of CDG of bus i at time t, πₜ^{IM} is the electricity price at the root of the system at time t, and Pₜ^{IM} is the injects power at the system root at time t, that is, a system total load.

The present embodiment takes the cost function of the controllable DG as a quadratic function, that is: C(P_{i,t}^{CDG})=aᵢ(P_{i,t}^{CDG})²+bᵢP_{i,t}^{CDG}+cᵢ, in which aᵢ, bᵢ, cᵢ are the cost function coefficients for the CDG of bus i.

The constraints of the present embodiment include:

1) Current law of Kirchhoff:

(P_{i,t}^{IL}+P_{i,t}^{CL}−P_{i,t}^{CDG}−Pᵢₜ^{UDG})+Σ_{j∈δ}_{ᵢ}P_{ij,t}−Σ_{k∈η}_{ᵢ}(P_{ki,t}−rₖᵢI_{ki,t}^{sqr})=0, i ∈ S_{bus}, t ∈ [1, T]

(Q_{i,t}^{IL}+χᵢ^{CL}P_{i,t}^{CL}−Q_{i,t}^{CDG}−Q_{i,t}^{UDG})+Σ_{j∈δ}_{ᵢ}Q_{ij,t}−Σ_{k∈η}_{ᵢ}(Q_{ki,t}−xₖᵢI_{ki,t}^{sqr})=0, i ∈ S_{bus}, t ∈[1, T],

in which P_{i,t}^{IL}, P_{i,t}^{CL} and P_{i,t}^{UDG} are the active power for IL, CL, and UDG of bus i respectively at time t. Q_{i,t}^{IL}, Q_{i,t}^{CDG} and Q_{i,t}^{UDG} are the reactive power for IL, CDG, and UDG of bus i respectively at time t. χᵢ^{CL} is the power factor of the CL of bus i. δᵢ and ηᵢ are a bus set of downstream/upstream bus esrespectively. P_{i,j,t}, Q_{ij,t} and I_{ij,t}^{sqr} are the active/reactive power of branch ij and the square of the branch current at time t respectively. rₖᵢ and xₖᵢ are the resistance and reactance of branch ki respectively.

At the same time, when i is the root, it should be: Σ_{j∈δ}_{ᵢ}P_{ij,t}−Pₜ^{IM}=0, t ∈ [1, T]

2) Voltage Law of Kirchhoff:

V_{i,t}^{sqr}−V_{j,t}^{sqr}−[2(P_{ij,t}rᵢⱼ+Q_{ij,t}xᵢⱼ)−(rᵢⱼ²+xᵢⱼ²)I_{ij,t}^{sqr}]=0, ij ∈ S_{brn}, t ∈ [1, T]

V_{j,t}^{sqr}I_{ij,t}^{sqr}≥P_{ij,t}²+Q_{ij,t}², ij ∈ S_{brn}, t ∈ [1, T], in which V_{i,t}^{sqr} is the square of the voltage of bus i at time t, and S_{brn} is the set of all lines of the distribution network. 3) Voltage and current constraints:

(V^{min})²≤V_{i,t}^{sqr}≤(V^{max})², i ∈ S_{bus}, t ∈ [1, T], 0≤I_{ij,t}^{sqr}≤(Iᵢⱼ^{max})², ij ∈ S_{brn}, t ∈ [1, T], in which V^{min} and V^{max} are the upper and lower limits of bus voltage respectively, and Iₗⱼ^{max} is the upper limit of current of branch ij.

4) CDG personal constraints includes a CDG maximum output constraint and a climbing constraint:

$$\{ \begin{matrix}{( {P}_{i , t}^{CDG} )}^{2} + {( {Q}_{i , t}^{CDG} )}^{2} \leq {( {S}_{i}^{CDG} )}^{2} \\ {P}_{i , t}^{CDG} \geq 0\end{matrix} , \\ i ∈ {S}_{bus \cdot } , t ∈ [ 1 , T ] ,$$

rᵢ^{CDG,down}≤P_{i,t}^{CDG}−P_{i,t-1}^{CDG}≤rᵢ^{CDG,up}, i ∈ S_{bus}, t ∈ [2, T], in which Sᵢ^{CDG} is the upper limit of the apparent power for CDG of bus i. rᵢ^{CDG,down} and rᵢ^{CDG,up} are upper limits of downward/upward ramping rate for bus i respectively.

5) UDG personal restraint: (P_{i,t}^{UDG})²+(Q_{i,t}^{UDG})²≤(Sᵢ^{UDG})², i ∈ S_{bus}, t ∈ [1, T] in which S_{I}^{UDG} is the upper limit of the apparent power for UDG of bus i.

6) IL personal constraints:

Σ_{t=T}_{ᵢ}_{^{start}}^{T}^{ᵢ}^{^{end}}P_{i,t}^{IL}ΔT=Wᵢ^{IL}, i ∈ S_{bus}, t ∈ [1, T]

0≤P_{i,t}^{IL}≤P_{i,t}^{IL,max}, i ∈ S_{bus}, t ∈ [Tᵢ^{start}, Tᵢ^{end}]

P_{i,t}^{IL}=0, i ∈ S_{bus}, t ∈ [1, T]\[Tᵢ^{start}, Tᵢ^{end}]

χᵢ^{IL}P_{i,t}^{IL}=Q_{i,t}^{IL}, i ∈ S_{bus}, t ∈ [1, T], in which Tᵢ^{start}, Tᵢ^{end}, Wᵢ^{IL} and χᵢ^{IL} are the earliest start/latest end periods, total power demand, and power factor for IL of bus i respectively, and ΔT is the time length of the periods. Pᵢ^{IL,max} is the upper limit of the charging power for IL of bus i.

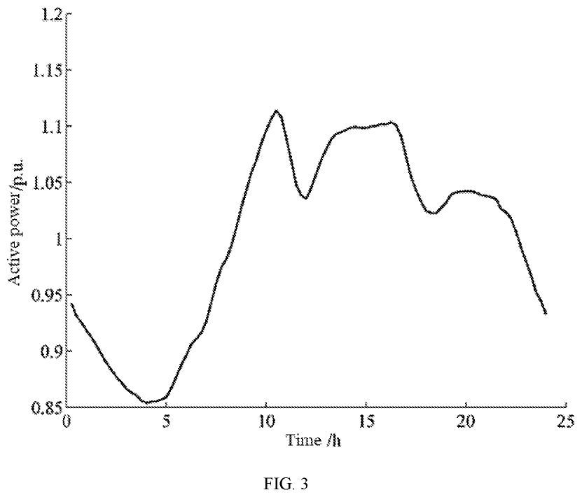

In the present embodiment, an improved 119-bus radial power distribution system structure is used. In the system, a UDG output prediction curve is obtained according to a photovoltaic 24-hour typical active power output curve; and a CL load prediction curve is obtained according to a certain typical 24-hour load curve, as shown in FIG. 3. The electricity price at the system root adopts a watt hour tariff part of the two-part tariff of 35 kV electricity utilization in summer business and other industries in Shanghai area, that is, The electricity price of peak periods (8-11, 13-15, 18-21) is 1.227 RMB/kWh, the electricity price of ordinary periods (6-8, 11-13, 15-18, 21-22) is 0.757 RMB/kWh, and the electricity price of valley periods (22-6 the next day) is 0.293 RMB/kWh.

An energy blockchain is established according to the method designed by the present invention based on scenarios in the energy system of the embodiment to test the performance of the blockchain model designed by the present invention. The computer configuration environment supporting the embodiment is as follows:

| Software/Hardware | Version/Model |
|---|---|
| Operating system | Windows 8.1 |
| Memory | 8GB RAM |
| CPU | Intel Core i5-4590 3.1 GHz |
| Matlab | R2014a |

Difficult (costly, time-consuming) to produce but easy for others to verify Complex solution and simple verification is the key for all nodes in the network to maintain consensus. In the embodiment, the results of the solution time and the verification time for the consensus algorithm under the PoO mechanism are shown in the table below:

| | Average time/s | Longest time/s | Shortest time/s |
|---|---|---|---|
| Solving model | 309.22 | 479.41 | 153.76 |
| Verification result | 0.66 | 0.86 | 0.63 |

From the above table, it can be seen that the solution time of the PoO is much greater than the verification time. Thus, in the PoO algorithm, the work that the node needs to complete has a certain workload, and a verifier can quickly verify whether the work is correct, which guarantees the consensus of the decentralized network.

The block time is an important performance index of the blockchain model; the shorter the block time is, the smaller the time delay is created by the trade, thereby reducing the waiting time of the participants. The block time can be defined by the following expression:

T_{block}−T_{Consensus}−T_{broadcast}, in which T_{block} is the block time, T_{Consensus} is the solution time of consensus algorithm, and T_{broadcast} is the time required for block broadcasting. Since the time required by T_{broadcast} is basically determined in a system with a determined node scale, the present embodiment mainly discusses the relationship between consensus T_{Consensus} and related influencing factors.

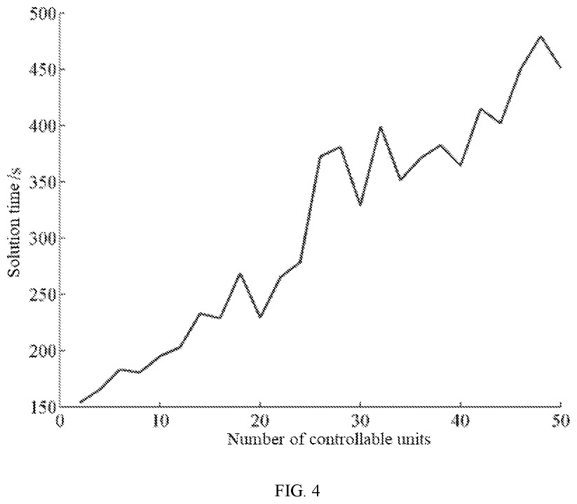

According to the embodiment, the solution period number is fixed to 48 time periods, the objective functions and constraints of the participants are randomly generated, and the relationship between the solution time and the number of controllable units (DG and IL) is obtained and shown in FIG. 4.

As shown in FIG. 4, the significant advance of the present method is that:

1) The energy blockchain in the present embodiment is scalable. The controllable units can join and exit the energy blockchain at will without affecting the stability of the blockchain network.

2) The throughput capacity of the energy blockchain in the present embodiment can meet the demands of renewable power supply trades in current distribution network. Each T_{Consensus} of different numbers of controllable units is much smaller than the time length of a single time period (15 minutes) under the current computer environment with mainstream configuration, which guarantees an orderly and continuous operation of renewable energy in the distribution network.

3) The T_{Consensus} in the present embodiment is approximately in direct proportion to the number of controllable units. A certain deviation exists in part of nodes, which is presumably related to boundary conditions of the controllable units. Thus it can be seen that the broadcast information of the controllable units will affect the solution time to some extent.

The foregoing specific embodiment can be locally adjusted in different ways by those skilled in the art without departing from the principles and spirit of the invention. The scope of the invention complies with the claims and is not limited by the foregoing specific embodiment, and all implementations within the scope thereof are constrained by the invention.

What is claimed is:

1. A blockchain-based optimization method for complex scenarios in an energy system, comprising:
solving an optimization problem by nodes in whole network after initialization;
obtaining a block accounting right by a node that solves the problem most quickly, and performing a broadcast to the whole network by the node;
verifying correctness of blocks received by other nodes; and
confirming a verified block as the global optimal solution of an energy system optimization model, and broadcasting the block to the whole network, wherein
the block includes a block header and a block body, the block header storing the root hash values of a variable tree, an objective function tree, a constraint tree, and a Lagrange multipliers tree in the model, and the block body storing variables, an objective function, constraints, and Lagrange multipliers in an MPT tree format.

2. The method according to claim 1, wherein the initialization means that intrinsic scenario information of the energy system is recorded in a genesis block which is used for defining the intrinsic information of the scenario: S₀=<T_{b}, X, f₀(X₀), g₀(X₀), h₀(X₀), cᵢ(X), dᵢ(X)>, i ∈ [0, n], wherein T_{b} is an appointed block time.

3. The method according to claim 1, wherein the block body further includes a variable tree (VT), an objective tree (OT), a constraint tree (CT), a λ-multiplier tree (λT), and a μ-multiplier tree (μT).

4. The method according to claim 1, wherein the optimization problem is solved by nodes in the whole network, that is, each node broadcasts the energy system optimization model and constraints to the whole network, and collects and packs all legal broadcasts into a block.

5. The method according to claim 1, wherein the energy system optimization model refers to:
min(Σᵢ₌₀^{N}fᵢ(Xᵢ)),
s.t. gᵢ(Xᵢ)=0, i ∈ [0, n], hᵢ(Xᵢ)≤0, i ∈ [0, n], cᵢ(X)=0, i ∈ [0, n], dᵢ(X)≤0, i ∈ [0, n], wherein decision variables are divided into n+1 groups; the ith group of decision variables Xᵢ corresponds to a relatively independent objective function fᵢ(Xᵢ) and simple constraint sets gᵢ(Xᵢ) and hᵢ(Xᵢ); X is a set of all decision variables; and constraint sets cᵢ(X) and dᵢ(X) are complex constraints that couple each group of decision variables.

6. The method according to claim 4, wherein the constraints are based on distribution network participating individuals, that is, a controllable distributed generation, an uncontrollable distributed generation, an intelligent load and a conventional load, and specifically include Kirchhoff current/voltage law, voltage and current constraints, CDG personal constraint, UDG personal constraints, and IL personal constraint.

7. The method according to claim 1, wherein the block accounting right means that the node that solves the problem most quickly packs a solution result of the optimization problem into the block and performs the broadcast to the whole network, which specifically means that the node i that solves the problem most quickly will broadcast information Sᵢ=<Xᵢ, fᵢ(Xᵢ), gᵢ(Xᵢ), hᵢ(Xᵢ)>, thereof to the whole network, other nodes in the network firstly add the collected the information to the objective tree and the constraint tree respectively, solve the optimization model after collecting all the information, update the variable tree, the λ-multiplier tree and the μ-multiplier tree according to the solution result, and produce a new block and broadcast to the whole network.

8. The method according to claim 1, wherein the correctness verification means that other nodes verify the KKT condition in the received block.

9. The method according to claim 1, wherein the correctness verification specifically means that the optimality of the solution involved in the block which is determined and verified according to each constraint of Lagrange function of the optimization model after the node receives the new block, including:
∂L/∂X=0, μ*ᵢhᵢ(X*ᵢ)=0, i ∈ [0, n], β*ᵢdᵢ(X*)=0, i ∈ [0, n], λ*ᵢ, α*ᵢ ≠ 0, i ∈ [0, n], μ*ᵢ, β*ᵢ≥0, i ∈ [0, n], wherein X* is an optimal solution in the new block, λ*ᵢ. μ*ᵢ, α*ᵢ, β*ᵢ are the Lagrange multipliers in the new block respectively; and the node confirms the block, broadcasts to the whole network, and starts to contend for the next block when the new block satisfies the above determination which means that the solution in the block is the global optimal solution for the problem.

10. The method according to claim 8, wherein the correctness verification specifically means that the optimality of the solution involved in the block which is determined and verified according to each constraint of Lagrange function of the optimization model after the node receives the new block, including:
∂L/∂X=0, μ*ᵢhᵢ(X*ᵢ)=0, i ∈ [0, n], β*ᵢdᵢ(X*)=0, i ∈ [0, n], λ*ᵢ, α*ᵢ ≠ 0, i ∈ [0, n], μ*ᵢ, β*ᵢ≥0, i ∈ [0, n], wherein X* is an optimal solution in the new block, λ*ᵢ, μ*ᵢ, α*ᵢ, β*ᵢ are the Lagrange multipliers in the new block respectively; and the node confirms the block, broadcasts to the whole network, and starts to contend for the next block when the new block satisfies the above determination which means that the solution in the block is the global optimal solution for the problem.
